(19) United States
(12) Patent Application Publication
(10) Pub. No.: US 2021/0190172 A1
(43) Pub. Date: Jun. 24, 2021

(54) TORSIONAL VIBRATION DAMPER WITH A FRICTION PLATE

(71) Applicant: Schaeffler Technologies AG & Co. KG, Herzogenaurach (DE)

(72) Inventors: Guilherme Camara, Sorocaba (BR); Steve Lauderbaugh, Danville, MI (US)

(73) Assignee: Schaeffler Technologies AG & Co. KG, Herzogenaurach (DE)

(21) Appl. No.: 16/720,630

(22) Filed: Dec. 19, 2019

(51) Int. Cl. F16F 15/129; F16F 15/14; F16F 15/121

(52) U.S. Cl. CPC F16F 15/1295; F16F 15/1213; F16F 15/1428

(57) ABSTRACT

A torsional vibration damper, including: a hub supported for rotation around an axis of rotation; a first damper stage including a first damper flange non-rotatably connected to the hub and a first spring engaged with the first damper flange; a second damper stage including a second damper flange and a second spring, radially off-set from the first spring, and engaged with the second damper flange; and a friction control plate non-rotatably connected to the hub, free of contact with the first spring and free of contact with the second spring, and directly engaged with the second damper stage.

### TECHNICAL FIELD

The present disclosure relates to a torsional vibration damper with an idle damper hysteresis greater than a main damper hysteresis.

### BACKGROUND

For known two-stage torsional vibration dampers, hysteresis is used to dampen vibration. For these known two-stage torsional vibration dampers, a hysteresis associated with an idle damper stage (for example at engine start-up) is less than a hysteresis associated with a main damper stage.

### SUMMARY

According to aspects illustrated herein, there is provided a torsional vibration damper, including: a hub supported for rotation around an axis of rotation; a first damper stage including a first damper flange non-rotatably connected to the hub and a first spring engaged with the first damper flange; a second damper stage including a second damper flange and a second spring, radially off-set from the first spring, and engaged with the second damper flange; and a friction control plate non-rotatably connected to the hub, free of contact with the first spring and free of contact with the second spring, and directly engaged with the second damper stage.

According to aspects illustrated herein, there is provided a torsional vibration damper, including: a hub; a first damper flange non-rotatably connected to the hub; a first spring directly engaged with the first damper flange; a second damper flange directly engaged with the first spring; a second spring directly engaged with the second damper flange and radially off-set from the first spring; a first damper plate directly engaged with the second spring; and a friction control plate non-rotatably connected to the hub and in contact with the second damper flange or directly engaged with the second damper flange, free of contact or engagement with the first spring, and free of contact or engagement with the second spring. One of the first damper plate or the hub is arranged to receive a rotational torque as an input to the torsional vibration damper. An other of the first damper plate or the hub is arranged to transmit the rotational torque as an output of the torsional vibration damper. For the rotational torque less than a threshold value, the hub is arranged to rotate the friction control plate with respect to the second damper flange, and the second damper flange is non-rotatable with respect to the first damper plate. For the rotational torque equal to or greater than the threshold value, the hub is arranged to rotate the friction control plate with respect to the second damper flange, and the second damper flange is arranged to rotate with respect to the first damper plate.

According to aspects illustrated herein, there is provided a torsional vibration damper, including: a hub; a first damper flange non-rotatably connected to the hub; a first spring directly engaged with the first damper flange; a second damper flange directly engaged with the first spring; a second spring directly engaged with the second damper flange and radially off-set from the first spring; a damper plate directly engaged with the second spring; a friction control plate non-rotatably connected to the hub, free of contact or engagement with the first spring, and free of contact or engagement with the second spring; and a resilient element urging the friction control plate into contact with the second damper flange.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front isometric view a torsional vibration damper with a friction control plate;

FIG. 2 is a back isometric view of the torsional vibration damper shown in FIG. 1;

FIG. 3 is a front view of the torsional vibration damper shown in FIG. 1;

FIG. 4 is an exploded view of the torsional vibration damper shown in FIG. 1;

FIG. 5 is a cross-sectional view generally along line 5-5 in FIG. 3;

FIG. 6 is a back view of the torsional vibration damper shown in FIG. 1 with a damper plate removed;

FIG. 7 is a cross-sectional view generally along line 7-7 in FIG. 3;

FIG. 8 is an isometric front view of a hub and the friction control plate of the torsional vibration damper shown in FIG. 1;

FIG. 9 is an isometric view of the friction control plate in FIG. 1.

### DETAILED DESCRIPTION

At the outset, it is appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It is understood that any methods, devices or materials similar or equivalent to those described herein can be used in the practice or testing of the disclosure.

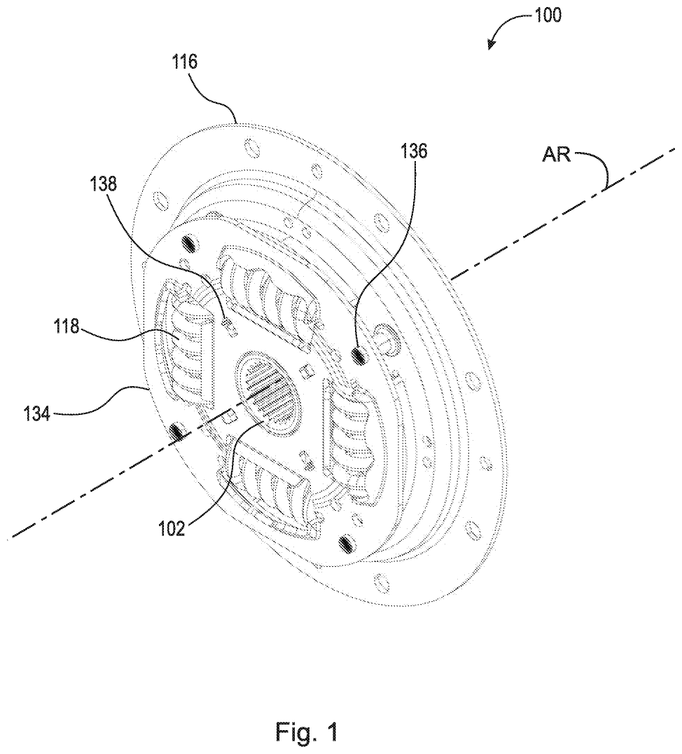

FIG. 1 is a front isometric view of torsional vibration damper 100 with a friction control plate.

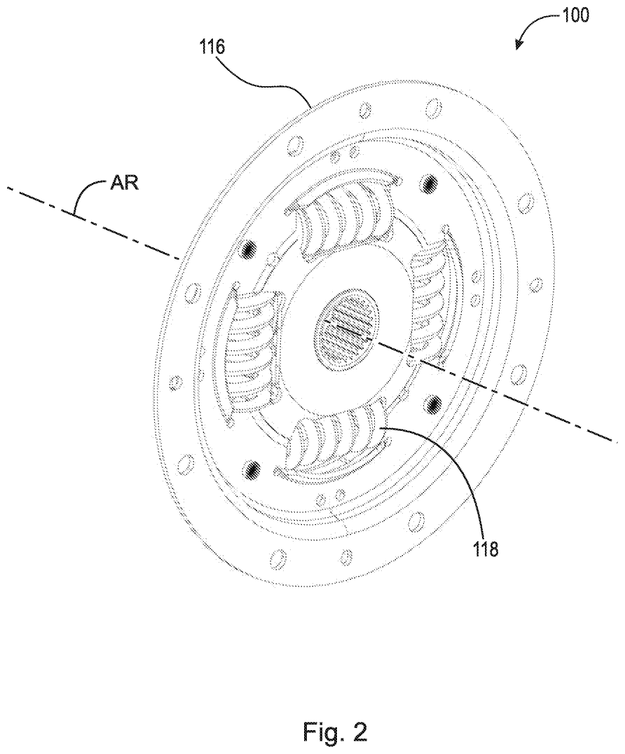

FIG. 2 is a back isometric view of torsional vibration damper 100 shown in FIG. 1.

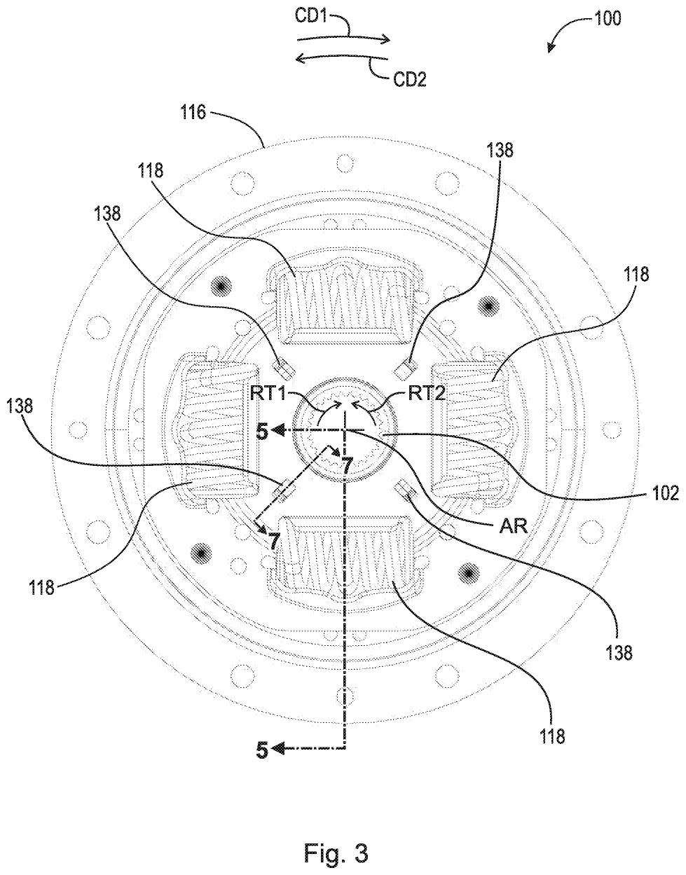

FIG. 3 is a front view of torsional vibration damper 100 shown in FIG. 1.

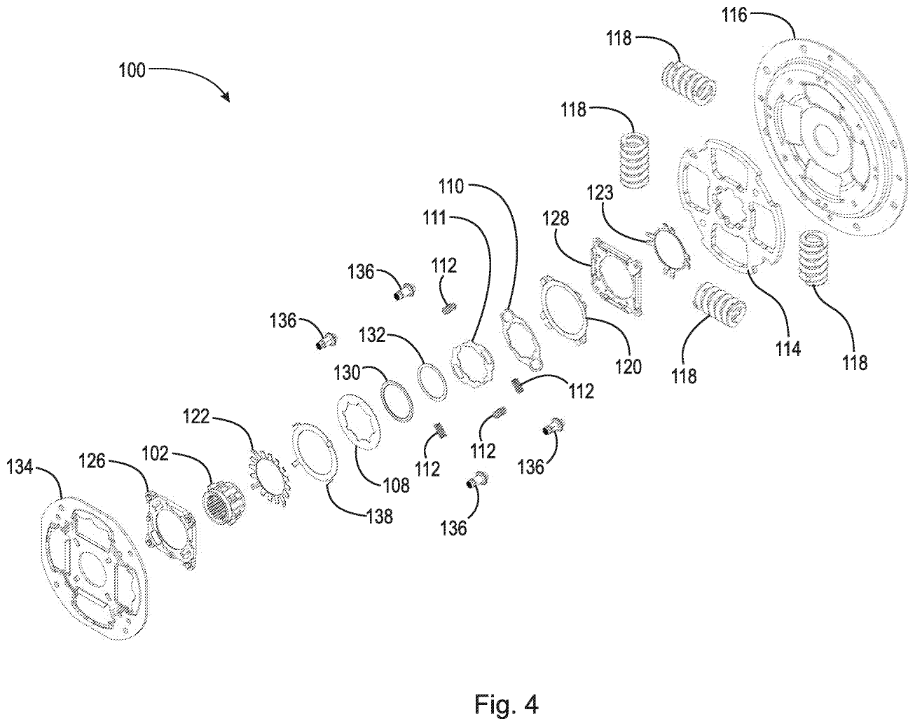

FIG. 4 is an exploded view of torsional vibration damper 100 shown in FIG. 1. The following is viewed in light of FIGS. 1 through 4. Torsional vibration damper 100, includes: hub 102; idle damper stage 104; main damper stage 106; and friction control plate 108. Friction control plate 108 is non-rotatably connected to hub 102 and is directly engaged with main damper stage 106. Hub 102 is supported for rotation around axis of rotation AR.

By “non-rotatably connected” components, we mean that the components are connected so that whenever one of the components rotates, all the components rotate; and relative rotation between the components is precluded. Radial and/or axial movement of non-rotatably connected components with respect to each other is possible. Components connected by tabs, gears, teeth, or splines are considered as non-rotatably connected despite possible lash inherent in the connection. The input and output elements of a closed clutch are considered non-rotatably connected despite possible slip in the clutch. The input and output parts of a vibration damper, engaged with springs for the vibration damper, are not considered non-rotatably connected due to the compression and unwinding of the springs. In the example of FIG. 1, friction control plate 108 is displaceable parallel to axis AR.

By one component “directly engaged with” another component, we mean that the components are in direct contact, or that the components are in direct contact with one or more ancillary intermediate parts, for example, a cap fixed to an end of a spring, such that the components and the ancillary parts are mechanically solid. A possible function of the ancillary parts is to protect the components from wearing against each other.

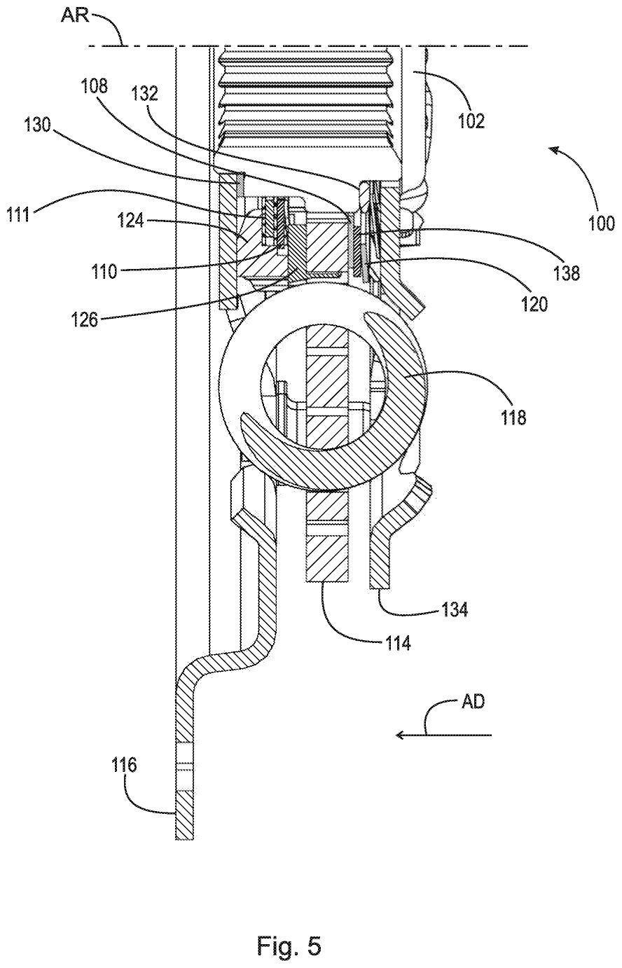

FIG. 5 is a cross-sectional view generally along line 5-5 in FIG. 3.

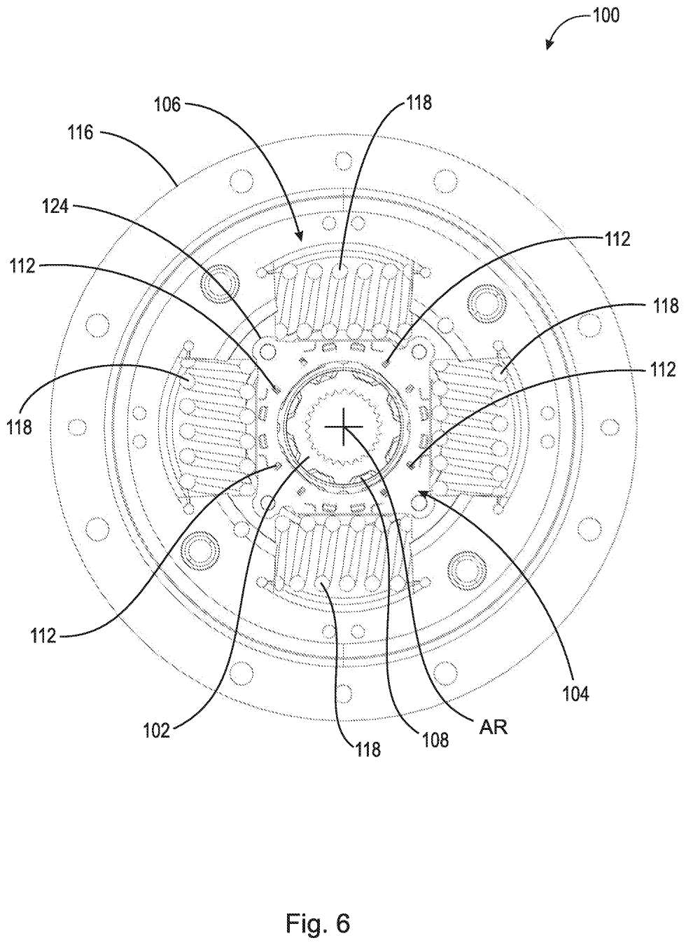

FIG. 6 is a back view of torsional vibration damper 100 shown in FIG. 1 with a damper plate removed. The following is viewed in light of FIGS. 1 through 6. In an example embodiment, idle damper stage 104 includes: damper flange 110 non-rotatably connected to hub 102; damper flange 111 non-rotatably connected to hub 102; and springs 112 directly engaged with damper flange 110 and with damper flange 111.

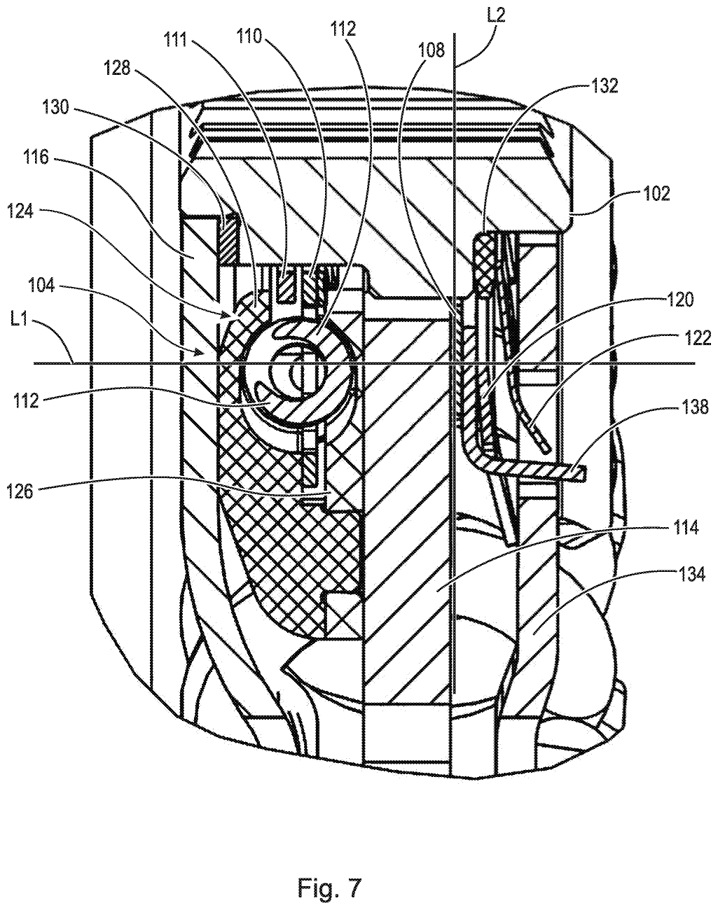

FIG. 7 is a cross-sectional view generally along line 7-7 in FIG. 3. The following is viewed in light of FIGS. 1 through 7. In an example embodiment, main damper stage 106 includes: damper flange 114 directly engaged with springs 112; damper plate 116; and springs 118

directly engaged with damper flange 114 and with damper plate 116. Friction control plate 108 is directly engaged with damper flange 114. In the example of FIG. 1, friction control plate 108 is in contact with damper flange 114. Springs 118 are radially off-set from springs 112. In the example of FIG. 1, springs 118 are radially outward of springs 112. Friction control plate 108 is free of contact with springs 112 and springs 118.

One of damper plate 116 or hub 102: is arranged to receive rotational torque RT1 or RT2 in circumferential direction CD1 or opposite circumferential direction CD2, respectively, as an input to torsional vibration damper 100; and is supported for rotation about axis of rotation AR. The other of damper plate 116 or hub 102 is arranged to transmit torque RT1 and RT2 as an output of torsional vibration damper 100 and is supported for rotation about axis of rotation AR.

Torsional vibration damper 100 includes resilient element 120 and resilient element 122. In the example of FIG. 1, element 120: urges friction control plate 108 in axial direction AD, parallel to axis AR, into contact with main damper stage 106. For example, element 120 urges friction control plate 108 into contact with damper flange 114.

Element 122 urges hub 102 in direction AD and into direct engagement with main damper stage 106. In an example embodiment, torsional vibration damper 100 includes resilient element 123. Element 123 urges hub 102 in direction AD and into direct engagement with main damper stage 106. Resilient elements 120, 122, and 123 can be any resilient elements known in the art, including but not limited to diaphragm springs.

In an example embodiment, main damper stage 106 includes cage 124. In an example embodiment, cage 124 includes: portion 126 non-rotatably connected to damper flange 114; and portion 128 non-rotatably connected to portion 126. At least a portion of spring 112 is disposed within cage 124. Resilient element 120 urges: damper flange 114 and cage 124 in direction AD; and cage 124 into direct engagement with plate 116. In an example embodiment, resilient element 120 urges cage 124 into contact with plate 116.

In an example embodiment, torsional vibration damper 100 includes friction ring 130 and friction ring 132. Friction rings 130 and 132 are made of any friction material known in the art. Friction ring 130 is axially disposed between hub 102 and damper plate 116. Friction ring 132 is axially disposed between hub 102 and resilient element 122. In the example of FIG. 1, resilient elements 122 and 123: urge hub 102 in axial direction AD to contact friction ring 130 with hub 102 and damper plate 116; and urge friction ring 132 into contact with hub 102.

In an example embodiment, main damper stage 106 includes damper plate 134 non-rotatably connected to damper plate 116, for example with bolts 136. In an example embodiment, friction control plate 108 is disposed between damper flange 114 and damper plate 134 in direction AD. In an example embodiment, torsional vibration damper 100 includes support washer 138 axially disposed between resilient element 120 and friction control plate 108. Resilient element 120 urges washer 138 in direction AD to contact friction control plate 108 and urge friction control plate in direction AD.

In an example embodiment, hypothetical line L, parallel to axis AR passes through in sequence: damper plate 116; portion 128; a spring 112; portion 126; damper flange 114; friction control plate 108; support washer 138; resilient element 120; resilient element 122; and damper plate 134. In an example embodiment, any hypothetical line, orthogonal to axis AR and passing through friction control plate 108, passes through hub 102. For example, hypothetical line L2, orthogonal to axis AR, passes through friction control plate 108 passes and hub 102. Line L2 does not pass through damper flange 110, damper flange 111, damper flange 114, damper plate 116, or damper plate 134. In the example of FIG. 1, an entirety of friction control plate 108 is located radially outward of hub 102.

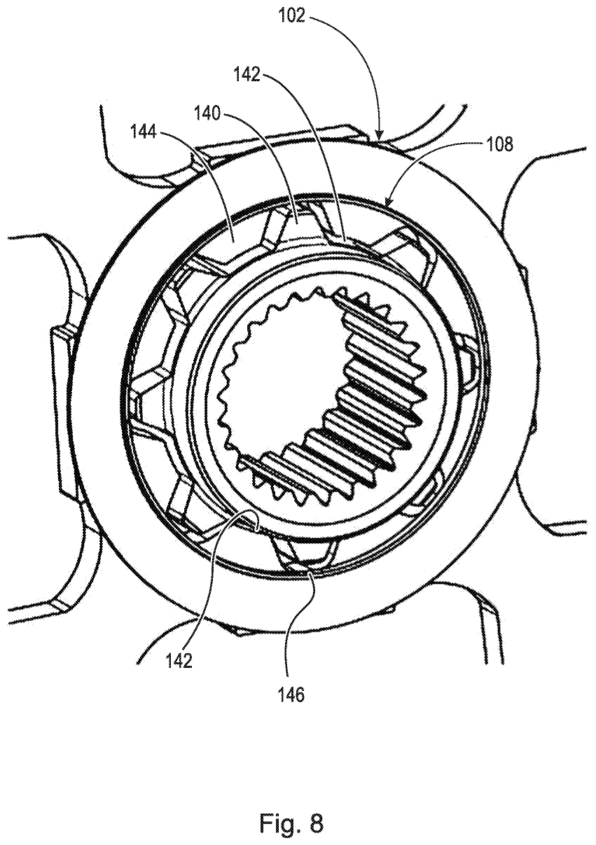

FIG. 8 is an isometric front view of hub 102 and friction control plate 108 of the torsional vibration damper 100 shown in FIG. 1.

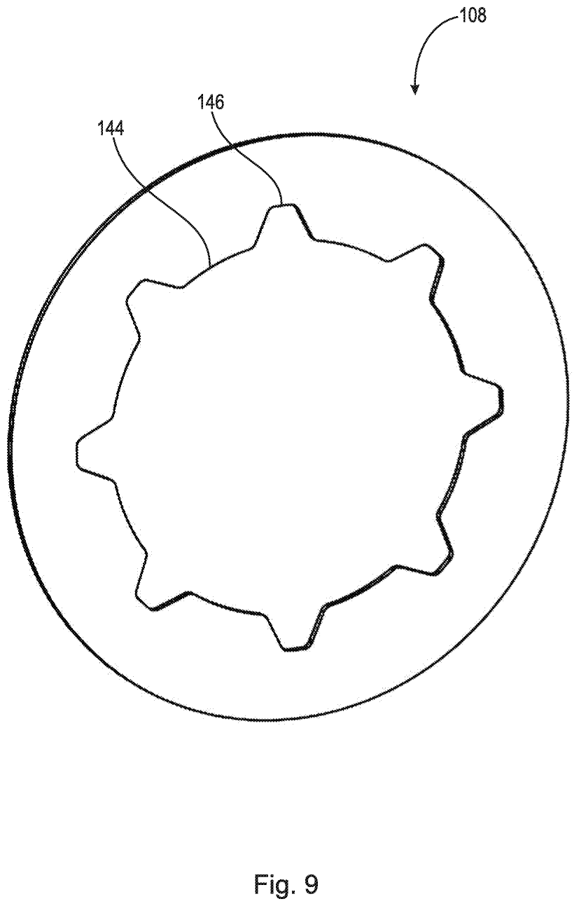

FIG. 9 is an isometric view of friction control plate 108 in FIG. 1. The following is viewed in light of FIGS. 1 through 9. In an example embodiment: hub 102 includes radially outwardly extending splines, or teeth, 140 and slots 142; and friction control plate 108 includes radially inwardly extending splines, or teeth 144, disposed in slots 142, and slots 146 into which splines 140 are disposed. The interleaving of splines 140, slots 146, splines 144, and slots 142 non-rotatably connects hub 102 and friction control plate 108.

The discussion that follows is directed to operation of torsional vibration damper 100 with torque RT1 applied to damper plate 116 as the input to torsional vibration damper 100. It is understood that the discussion is applicable to operation of torsional vibration damper 100 with: torque RT2 applied to damper plate 116 as an input to torsional vibration damper 100; torque RT1 applied to hub 102 as an input to torsional vibration damper 100; and torque RT2 applied to hub 102 as an input to torsional vibration damper 100.

In an idle mode of torsional vibration damper 100, torque RT1, for example from an internal combustion engine (not shown), is transmitted to damper plate 116 as an input to torsional vibration damper 100. Torque RT1 is less than threshold torque value TTV. Torque RT1 is not great enough to compress springs 118; therefore damper plate 116, springs 118, and damper flange 114 act as a solid mechanical unit transmitting torque RT1 to springs 112. Vibration associated with torque RT1 causes springs 112 to compress and unwind as springs 112 transmit torque RT1 to hub 102. The compression and unwinding of springs 112: causes relative rotation between hub 102 and damper flange 114 and damper plate 116; and relative rotation between friction control plate 108 and damper flange 114.

In the example of FIG. 1 and for the idle mode, a total hysteresis is generated by: frictional contact between hub 102 and friction control plate 108; frictional contact among friction ring 130, damper plate 116, and hub 102; and frictional contact among hub 102, friction ring 132, resilient element 122, and resilient element 123. Since there is no relative rotation between damper flange 114 and damper plate 116, there is no hysteresis generated by contact of cage 124 with damper plate 116. The frictional contact of friction ring 130 and friction ring 132 with the other components noted above occurs on the respective sides of ring 130 and 132 offering the least resistance.

In a main mode of torsional vibration damper 100, torque RT1, for example from an internal combustion engine (not shown), is transmitted to damper plate 116 as an input to torsional vibration damper 100. Torque RT1 is greater than or equal to threshold torque value TTV. Springs 118 compress and unwind in response to torque RT1 to dampen vibration associated with torque RT1. Springs 118 transmit torque RT1 to damper flange 114, which in turn transmits torque RT1 to springs 112. Torque RT1 is large enough to fully compress springs 112 such that damper flange 110, springs 112, and damper flanges 110 and 111 act as a solid mechanical unit transmitting torque RT1 to hub 102. As is known in the art, damper flange 114 contacts damper flanges 110 and 111 to prevent damage to springs 112 due to over-compression of springs 112.

In the example of FIG. 1 and for the main mode, resilient element 120 urges damper flange 114 in direction AD to contact damper plate 116 with cage 124. Cage 124 is non-rotatably connected to damper flange 114 and the compression and unwinding of springs 118 causes relative rotation between damper flange 110/cage 124 and damper plate 116. In the example of FIG. 1 and for the main mode, the total hysteresis is generated by: frictional contact between hub 102 and friction control plate 108; frictional contact among friction ring 130, damper plate 116, and hub 102; frictional contact among hub 102, friction ring 132, resilient element 122, and resilient element 123; and frictional contact between cage 124 and damper plate 116.

Torsional vibration damper 100 provides an increased idle mode hysteresis, which for example, in an application in which torsional vibration damper 100 is connected to an internal combustion engine, reduces sensed vibration associated with: engine start-up; engine shut-down; large input torque changes coming from an engine throttle change; and feedback from tires due to tractive force changes.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A torsional vibration damper, comprising:
a hub supported for rotation around an axis of rotation;
a first damper stage including:
a first damper flange non-rotatably connected to the hub; and,
a first spring engaged with the first damper flange;
a second damper stage including:
a second damper flange; and,
a second spring, radially off-set from the first spring, and engaged with the second damper flange; and,
a friction control plate:
non-rotatably connected to the hub;
free of contact with the first spring and free of contact with the second spring; and,
directly engaged with the second damper stage.

2. The torsional vibration damper of claim 1, wherein:
the second damper stage includes a damper plate directly engaged with the second spring and supported for rotation around the axis of rotation;
one of the damper plate or the hub is arranged to receive a rotational torque as an input to the torsional vibration damper; and,
the hub is arranged rotate the friction control plate with respect to the second damper flange.

3. The torsional vibration damper of claim 1, wherein:
the second damper stage includes a damper plate directly engaged with the second spring and supported for rotation around the axis of rotation;
one of the damper plate or the hub is arranged to receive a rotational torque as an input to the torsional vibration damper;
the friction control plate is in contact with the second damper flange; and,
the hub is arranged rotate the friction control plate with respect to the second damper flange.

4. The torsional vibration damper of claim 1, wherein:
the second damper flange is directly engaged with the first spring; or,
the second spring is radially outward of the first spring.

5. The torsional vibration damper of claim 1, wherein:
the second damper stage includes a damper plate directly engaged with the second spring, the torsional vibration damper further comprising:
a resilient element urging the friction control plate into engagement with the second damper flange.

6. The torsional vibration damper of claim 1, wherein:
the second damper stage includes a damper plate directly engaged with the second spring, the torsional vibration damper further comprising:
a resilient element urging the friction control plate into contact with the second damper flange.

7. The torsional vibration damper of claim 1, further comprising:
a support washer; and,
a resilient element urging the support washer into contact with the friction control plate.

8. The torsional vibration damper of claim 1, wherein:
the second damper stage includes a cage;
at least a portion of the first spring is disposed within the cage; and,
the second damper stage includes a damper plate directly engaged with the second spring, the torsional vibration damper further comprising:
a resilient element urging the cage into contact with the damper plate.

9. The torsional vibration damper of claim 8, wherein the cage is fixed to the second damper flange.

10. The torsional vibration damper of claim 1, wherein:
the second damper stage includes a damper plate directly engaged with the second spring; and,
one of the damper plate or the hub is arranged to receive a rotational torque as an input to the torsional vibration damper, the torsional vibration damper further comprising:
a resilient element urging the hub into engagement with the damper plate.

11. The torsional vibration damper of claim 10, further comprising:
a first friction ring; and,
a second friction ring, wherein the resilient element:
urges the first friction ring into contact with the damper plate and the hub; and,
urges the second friction ring into contact with the hub.

12. The torsional vibration damper of claim 1, wherein a hypothetical line, parallel to the axis of rotation, passes through the first spring, the second damper flange, and the friction control plate.

13. The torsional vibration damper of claim 1, wherein:
the second damper stage includes a damper plate directly engaged with the second spring;
one of the damper plate or the hub is arranged to receive a rotational torque as an input to the torsional vibration damper; and,
a hypothetical line, parallel to the axis of rotation, passes through in sequence: the damper plate; the first spring; the second damper flange; and the friction control plate.

14. A torsional vibration damper, comprising:
a hub;
a first damper flange non-rotatably connected to the hub;
a first spring directly engaged with the first damper flange;
a second damper flange directly engaged with the first spring;
a second spring directly engaged with the second damper flange and radially off-set from the first spring;
a first damper plate directly engaged with the second spring; and,
a friction control plate:
non-rotatably connected to the hub and in contact with the second damper flange or directly engaged with the second damper flange;
free of contact or engagement with the first spring; and,
free of contact or engagement with the second spring, wherein:
one of the first damper plate or the hub is arranged to receive a rotational torque as an input to the torsional vibration damper;
an other of the first damper plate or the hub is arranged to transmit the rotational torque as an output of the torsional vibration damper;
for the rotational torque less than a threshold value, the hub is arranged to rotate the friction control plate with respect to the second damper flange, and the second damper flange is non-rotatable with respect to the first damper plate; and,
for the rotational torque equal to or greater than the threshold value, the hub is arranged to rotate the friction control plate with respect to the second damper flange, and the second damper flange is arranged to rotate with respect to the first damper plate.

15. The torsional vibration damper of claim 14, further comprising:
a resilient element urging the friction control plate into contact with the second damper flange.

16. The torsional vibration damper of claim 14, further comprising:
a resilient element; and,
a cage non-rotatably connected to the second damper flange, wherein:
at least a portion of the first spring is disposed within the cage; and,
the resilient element urges the cage into contact with the first damper plate.

17. The torsional vibration damper of claim 14, wherein an entirety of the friction control plate is located radially outward of the hub.

18. The torsional vibration damper of claim 14, further comprising:
a second damper plate non-rotatably connected to the first damper plate, wherein:
the hub and the second damper plate are supported for rotation around an axis of rotation; and,
the friction control plate is disposed between the second damper flange and the second damper plate in an axial direction parallel to the axis of rotation; or,
any hypothetical line, orthogonal to the axis of rotation and passing through the friction control plate, passes through the hub.

19. A torsional vibration damper, comprising:
a hub;
a first damper flange non-rotatably connected to the hub;
a first spring directly engaged with the first damper flange;
a second damper flange directly engaged with the first spring;
a second spring directly engaged with the second damper flange and radially off-set from the first spring;
a damper plate directly engaged with the second spring;
a friction control plate:
non-rotatably connected to the hub;
free of contact or engagement with the first spring; and,
free of contact or engagement with the second spring; and,
a resilient element urging the friction control plate into contact with the second damper flange.

20. The torsional vibration damper of claim 19, wherein:
one of the damper plate or the hub is arranged to receive a rotational torque as an input to the torsional vibration damper;
an other of the damper plate or the hub is arranged to transmit the rotational torque as an output of the torsional vibration damper;
for the rotational torque less than a threshold value, the hub is arranged to rotate the friction control plate with respect to the second damper flange, and the second damper flange is non-rotatable with respect to the damper plate; and,
for the rotational torque equal to or greater than the threshold value, the hub is arranged to rotate the friction control plate with respect to the second damper flange, and the second damper flange is arranged to rotate with respect to the damper plate.
